(19) United States
(12) Patent Application Publication
(10) Pub. No.: US 2009/0183202 A1
(43) Pub. Date: Jul. 16, 2009

(54) METHOD AND APPARATUS TO DISPLAY PROGRAM INFORMATION

(75) Inventors: Soo-yeoun YOON, Suwon-si (KR); Min-kyu PARK, Seoul (KR); Ji-yeon KWAK, Seoul (KR); Jung-chul PARK, Incheon (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/273,608

(22) Filed: Nov. 19, 2008

(30) Foreign Application Priority Data
Jan. 16, 2008 (KR) 2008-4911

(51) Int. Cl. H04N 5/445

(52) U.S. Cl. 725/41

(57) ABSTRACT

A method of displaying program information includes generating at least one representative video by extracting a part from video data of content, extracting at least one piece of additional information from the content, and generating the program information by assembling the generated at least one representative video and the extracted at least one piece of additional information. By using the method, moving picture program information is provided instead of table type program information. Accordingly, a user conveniently selects a desired content, while enjoying a moving picture, compared to a conventional of directly selecting the desired content based on the table type program information.

### CROSS-REFERENCE TO RELATED APPLICATIONS

This application claims the benefit and priority under 35 U.S.C. §119(a) of Korean Patent Application No. 10-2008-0004911, filed on Jan. 16, 2008, in the Korean Intellectual Property Office, the disclosure of which is incorporated herein in its entirety by reference.

### BACKGROUND OF THE INVENTION

1. Field of the Invention

The present general inventive concept relates to a method and apparatus to display program information, and more particularly, to a method and apparatus to display program information including a representative video and additional information.

2. Description of the Related Art

Electronic devices such as televisions (TVs) and personal computers (PCs) require a control system including a user interface (UI) system. In general, a UI provides a user with information, and simplifies usage with respect to the electronic devices. One example of a UI is an electronic program guide (EPG) in a TV system.

The EPG displays information similar to a TV program list which can be found in a local newspaper or other kinds of printed media, and includes information necessary for comparing and decoding programs. In general, the EPG provides information about each program which is within time frames which are covered by the EPG having a range of a next hour through next few days. The information included in the EPG comprises programming features such as channel numbers, program titles, a start time, an end time, a time elapsed, a time remaining, and brief descriptions about themes and program contents. In general, the EPG is disposed to have a two-dimensional table having one axis indicating time information and another axis indicating program source information such as channel information.

Recently, due to the increase in digital broadcasting systems, a user can have hundreds of channels. Thus, in order to provide the user with a large amount of broadcasting program information, information about a corresponding broadcasting is transmitted to the user, between each broadcasting signal, via the EPG, and the user can select and watch desired programs via the EPG.

A digital TV receives a plurality of pieces of EPG information about each channel in relation to a predetermined time interval, and stores the plurality of pieces of EPG information in a predetermined memory area within the digital TV. The stored plurality of pieces of EPG information are used so as to enable not only the user to tune into a specific channel but also to enable an EPG menu to be displayed on a screen of the digital TV by using a graphic processing block when the user searches for a plurality of pieces of program information based on time schedules and channels. Accordingly, the user can search for the desired programs by using the EPG menu, using various methods based on dates, the time schedules, and broadcasting stations.

FIG. 1 is a diagram for illustrating a screen of a conventional EPG system.

Referring to FIG. 1, a horizontal direction of the screen of the conventional EPG system indicates a broadcasting time, and a vertical direction of the screen indicates a channel. That is, the conventional EPG system displays table type program information based on the channel and the broadcasting time.

For example, a 9-2 channel broadcasts NEWS at 10:30-11:00, and an 11-1 channel broadcasts an MBC special high-definition (HD) drama JUMONG at 10:30-11:30.

However, considering a current situation in which multimedia contents have been geometrically increasing, users have many difficulties in selecting programs since the conventional EPG system is formed to be only a table type.

### SUMMARY OF THE INVENTION

The present general inventive concept provides a method and apparatus to display program information including a representative video of a multimedia content and additional information.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may e achieved by providing a method of displaying program information, the method including generating at least one representative video by extracting a part from video data of content, extracting at least one piece of additional information from the content, and generating the program information by assembling the generated at least one representative video and the extracted at least one piece of additional information.

The method may further include temporally and consecutively displaying the generated at least one representative video and the extracted at least one piece of additional information which are comprised in the program information.

The generating of the at least one representative video may include storing the content received via a communication network, and generating the at least one representative video by extracting the part from the video data of the stored content.

The generating of the at least one representative video may include generating the at least one representative video by further extracting audio data corresponding to the part extracted from the video data of the content.

The content may include Video on Demand (VOD) contents existing in websites via the Internet.

The extracting of the at least one piece of additional information may include extracting the at least one piece of additional information from metadata of the content.

The at least one piece of additional information may be displayed during a predetermined time.

The extracting of the at least one piece of additional information may further include searching for additional information corresponding to the content via a communication network.

The displaying may include displaying the at least one piece of additional information having at least one of a title of the content, a broadcasting date, a broadcasting time, and a channel number.

The method may further include generating at least one other representative video by extracting a part from video data of another content different from the content, extracting at least one other piece of additional information from the other content, generating another piece of program information by assembling the generated at least one other representative video and the extracted at least one other piece of additional information, and temporally and consecutively displaying respective program information.

The displaying may include temporally and consecutively displaying the respective program information, based on a first item for deciding the number of respective contents, a second item for deciding a time period during which the respective program information is displayed, and a third item comprising at least one of a viewing rate, a genre, a preference, and a broadcasting time.

The method may further include when the program information of the respective contents is displayed, displaying additional information, different from the displayed at least one additional information, on another screen that is different from a screen on which the program information is displayed when a first signal from among control signals via an input device is received, bookmarking the other content corresponding to the displayed other program information when a second signal is received, changing to a representative video of content to be displayed next when a third signal is received, and changing to a representative video of content which was previously displayed when a fourth signal is received.

The method may further include when the program information of the respective contents is displayed, extracting a keyword when an input signal related to the keyword is received, and changing to a content corresponding to the extracted keyword.

The foregoing and/or other aspects and utilities of the present general inventive concept may also be achieved by providing a program information display apparatus, the program information display apparatus including a representative video generation unit to generate at least one representative video by extracting a part from video data of content, an additional information extraction unit to extract at least one piece of additional information from the content, and a program information generation unit to generate the program information by assembling the generated at least one representative video and the extracted at least one piece of additional information.

The foregoing and/or other aspects and utilities of the present general inventive concept may also be achieved by providing a computer-readable medium to contain computer-readable codes as a program to execute a method of displaying program information in a program information displaying apparatus, the method including generating at least one representative video by extracting a portion from video data of a content, extracting at least one piece of additional information from the content, and generating the program information by assembling the generated at least one representative video and the extracted at least one piece of additional information.

The foregoing and/or other aspects and utilities of the present general inventive concept may also be achieved by providing a program information displaying apparatus including a user interface unit to generate a user interface, and a controller to control the user interface unit to generate the user interface to set the number of contents, and to generate a signal to display a combination of a representative video and additional information of the respective contents according to the set number of contents.

The foregoing and/or other aspects and utilities of the present general inventive concept may also be achieved by providing a program information displaying apparatus including a user interface unit to generate a user interface to display a bookmark list including bookmarked contents, and a controller to control the user interface unit to generate a signal to display a combination of a representative video and additional information of the respective bookmarked contents according to the bookmark list.

The foregoing and/or other aspects and utilities of the present general inventive concept may also be achieved by providing a program information displaying apparatus including a user interface unit to generate a signal to represent a user interface, and a controller to control the user interface unit to generate the user interface to display a first image of program information of a current item of a channel, a second image of program information of a previous item of the channel on a first side of the first image, a third image of program information of a next item of the channel on a second side of the first image, and a fourth image of at least one of additional information of the program information of the current item of the current channel and bookmark information of the current channel.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a diagram illustrating a screen of a conventional electronic program guide (EPG) system;

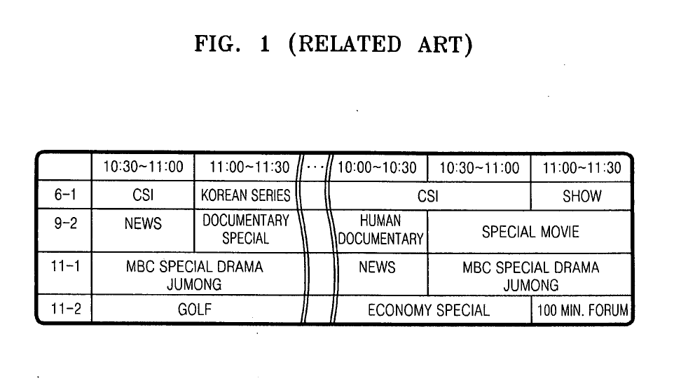

FIG. 2 is a block diagram illustrating an apparatus to display program information according to an embodiment of the present general inventive concept;

FIG. 3 is a block diagram illustrating a configuration of program information according to an embodiment of the present general inventive concept;

FIG. 4 is a diagram illustrating an example of a representative video and additional information, which are extracted from content and generated, and are assembled according to an embodiment of the present general inventive concept;

FIG. 5 is a diagram illustrating an example of additional information according to an embodiment of the present general inventive concept;

FIG. 6 is a diagram illustrating an example of a representative video included in program information according to an embodiment of the present general inventive concept;

FIG. 7 is a diagram illustrating a configuration of program information according to an embodiment of the present general inventive concept;

FIG. 8 is a diagram illustrating an example of a user interface (UI) to provide program information according to an embodiment of the present general inventive concept; and

FIG. 9 is a flowchart illustrating a method of displaying program information, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

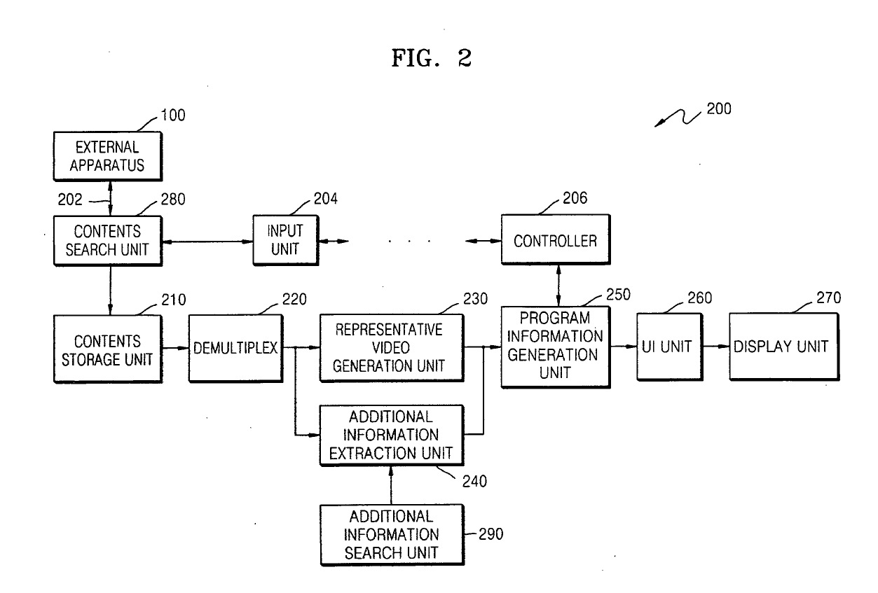

FIG. 2 is a block diagram illustrating an apparatus to display program information according to an embodiment of the present general inventive concept. The apparatus to display the program information (hereinafter, referred to as ‘a program information display apparatus 200’) according to the present embodiment provides program information including a representative video, and more particularly, the program information display apparatus 200 displays moving picture program information which is generated by temporally assembling a representative video of a content, and additional information. In the present embodiment, the program information may be an electronic program guide (EPG) as an example.

Referring to FIG. 2, the program information display apparatus 200 includes a contents storage unit 210, a demultiplexer 220, a representative video generation unit 230, an additional information extraction unit 240, a program information generation unit 250, a user interface (UI) unit 260, a display unit 270, a contents search unit 280, and an additional information search unit 290.

The program information display apparatus 200 may further include an input unit 204 to input one or more user inputs and preferences, and a controller 206 to control the contents storage unit 210, the demultiplexer 220, the representative video generation unit 230, the additional information extraction unit 240, the program information generation unit 250, the user interface (UI) unit 260, the display unit 270, the contents search unit 280, the additional information search unit 290, and the input unit 204 to perform operations thereof. The controller may control the operations according to an input signal input to the input unit 204.

The contents storage unit 210 stores contents received from each channel. The program information display apparatus 200 receives one or more contents via a communication network 202 from an external apparatus 100, for example, an external station, server or program (contents) provider. The stored contents may be contents which are being received in real-time, contents which have been previously received and stored, or previews of contents which are received but not broadcast yet. Also, in a case where the program information display apparatus 200 is connected to a network such as an Internet network, the stored contents may be Video on Demand (VOD) contents which have been in web sites before being searched for and downloaded from web sites by using the contents search unit 280. The contents search unit 280 may communicate with the external apparatus 100 through the communication network (or Internet) 202, for example, a wired or wireless communication line, to receive a signal representing the air or cable broadcast (contents) including one or more channels.

The demultiplexer 220 demultiplexes a broadcasting signal selected by a tuner (not illustrated but included in the contents search unit 280). That is, the demultiplexer 220 separates the broadcasting signal selected by the tuner into a video signal, an audio signal, and additional information.

The representative video generation unit 230 generates at least one representative video by extracting a portion from video data, that is, the video signal separated from the contents by the demultiplexer 220. In the present general inventive concept, the representative video may be a video generated by extracting a predetermined portion during a predetermined time period from the content (video data or broadcasting signal), or by extracting a highlight portion from the content. That is, a video, such as a preview of a movie, is generated. The extraction of the highlight portion may be performed by using a metadata method, or by using a digital contents management (DCM) method which extracts the highlight portion via video and audio analysis. However, the extraction of the portion from the video data such as the highlight part is not limited to the aforementioned extraction methods. In the metadata method, a broadcasting service provider extracts features from broadcasting contents so as to generate metadata, and transmits the metadata after editing, compressing, synchronizing, and multiplexing the metadata. A receiver, such as the program information display apparatus, demultiplexes or reconstructs the metadata included in the broadcasting contents, and extracts some scenes according to the reconstructed metadata. The generation of the representative video may also include generating the representative video by extracting not only the video data but also audio data synchronized with the video data. Also, the representative video having a plurality of scenes for each item of content may be generated by extracting a plurality of highlight scenes from the video data of the content. For example, a video (video image or video data) may be generated by extracting three highlight scenes from a movie and by assembling the three highlight scenes.

In the present embodiment, a video of a content may be reconstructed by extracting video data from the content. However, it is possible to receive a video separately having a highlight scene of the content, such as a preview, from a contents provider. The representative video may be at least one video image of moving video images of the content, and the at least one video image may have a resolution different from a resolution of the moving video images. If the content includes a plurality of still video images, the representative video may be one of the still video images. The selection or extraction of the representative video can be determined according to an input of the input unit 204, a user preference input through a menu generated by the UI unit 260, a random selection of the controller 206 or the representative video generation unit 230, or selection data included in the content.

The additional information extraction unit 240 extracts at least one piece of additional information separated by the demultiplexer 220. The at least one piece of additional information includes text data or information on the content and/or the video and audio data related to the content. An example of the at least one piece of additional information is text information to indicate contents of the corresponding content. The text information may include a title of the content, a broadcasting date, a broadcasting time, a channel number, characters, performers, a previous story, and the like. The at least one piece of additional information is also extracted by using the metadata of the content. In a case where there are a plurality of highlight scenes, there may also be a plurality of pieces of additional information to corresponding to the respective highlight scenes or the respective contents. The at least one piece of additional information may be displayed by searching for additional information corresponding to each item of the content by using the additional information search unit 290. For example, it may be possible to connect to a web site of the contents provider via the Internet, to download additional information about a corresponding content, and to transmit the additional information to the additional information extraction unit 240, thereby displaying the additional information.

The program information generation unit 250 generates the program information by assembling the generated at least one representative video and the extracted at least one piece of additional information. Also, the program information generation unit 250 temporally and consecutively displays the generated at least one representative video and the extracted at least one piece of additional information, which are included in the program information, on the display unit 270. The method temporally provides program information in which a representative video and additional information on a content are assembled. When the additional information is assembled with the representative video and displayed, the additional information including at least one of a title of the content, a broadcasting date, a broadcasting time, and a channel number may be first displayed on the representative video, since the additional information corresponds to basic information about the corresponding content. The additional information may be deleted after a predetermined time elapses, and then only the representative video may be reproduced or another piece of additional information may replace the additional information.

Here, the controller 206 controls the UI unit 260 to generate a signal to represent an image of the at least one representative video and the additional information of the program information, and the signal is transmitted to the display unit 270 such that the image of the at least one representative video and the additional information of the program information can be simultaneously, independently, or selectively displayed on different sections of a screen of the display unit 270 or can be superimposed on a same section of a screen of the display unit 270. It is possible that the controller 206 controls the UI unit 270 to generate signals to represent images of the at least one representative video and the additional information corresponding to the respective contents, and the signals are transmitted to the display unit 270 such that the respective images are selectively displayed on the display unit 270 as an electronic program guide (EPG).

The display unit 270 may not be installed in the program information display apparatus but may be an external display unit to be connected to the UI unit 270 through a wired or wireless communication line.

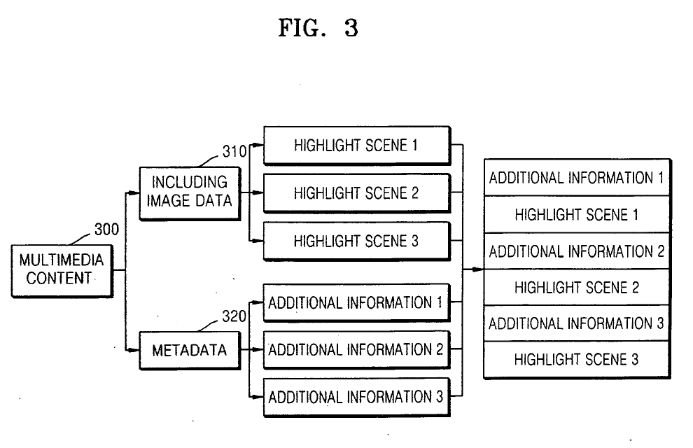

FIG. 3 is a block diagram illustrating program information according to an embodiment of the present general inventive concept. Referring to FIGS. 2 and 3, three highlight scenes and three pieces of additional information are extracted from multimedia content 300 including video data 310 and metadata 320 by displaying each of additional information 1, 2, and 3 on each of highlight scenes 1, 2, and 3. The additional information 1 is displayed while the highlight scene 1 is reproduced. There are no limitations to the number of highlight scenes and pieces of additional information which may be extracted.

Each combination of the additional information 1, 2, and 3 and the corresponding highlight scenes 1, 2 and 3 may be first, second, and third program information. One or more of the first, second, and third program information can be displayed in a screen of the display unit 270 under control of the UI unit 260 as an electronic program guide (EPG).

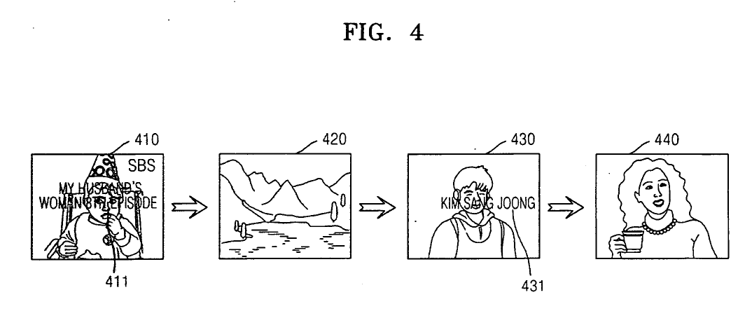

FIG. 4 is a diagram illustrating a representative video and additional information, which are extracted from content, generated, and assembled according to an embodiment of the present general inventive concept.

Referring to FIG. 4, each of scenes 410, 420, 430, and 440 indicates an image of the representative videos highlight scene. As program information, the images of the representative videos and the additional information are temporally and consecutively displayed. The initial image of the representative videos 410 indicates basic additional information of the content, and shows a title 411 of the content. In this case, the initial image of the representative videos 420 may be the highlight scene or may be a still image only indicating the additional information. The third image of the representative videos 430 indicates a name 431 of a hero in the content.

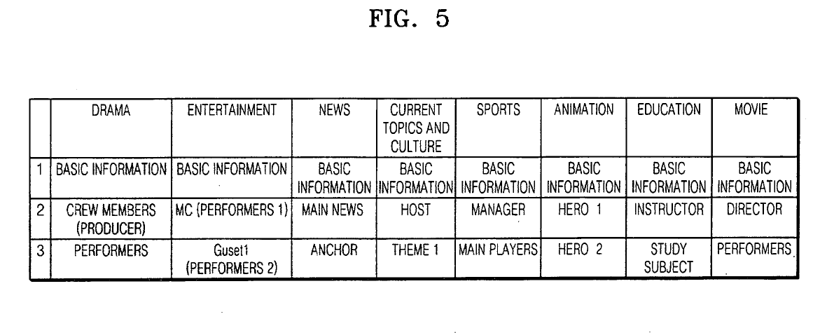

FIG. 5 is a diagram illustrating an example of additional information according to an embodiment of the present general inventive concept.

Referring to FIG. 5, a row in a horizontal direction of the example indicates a genre of each item of content, and a column in a vertical direction of the example indicates scenes extracted from each item of content, that is, the number of highlight scenes. In the case where one of each item of content is a drama, a highlight scene 1 displays the additional information that is basic information of the drama, such as a title of the drama, a time period of the drama, a broadcasting date, a broadcasting time, channel information, and the like. A highlight scene 2 displays the additional information about crew members or about productions which were produced by the crew members. A highlight scene 3 displays the additional information about performers, and productions in which the performers appeared. Each piece of additional information is displayed by being overlaid on each of the highlight scenes 1, 2, and 3, during a predetermined time period. After that, users may watch a representative video. However, the additional information about a contents provider may be constantly displayed.

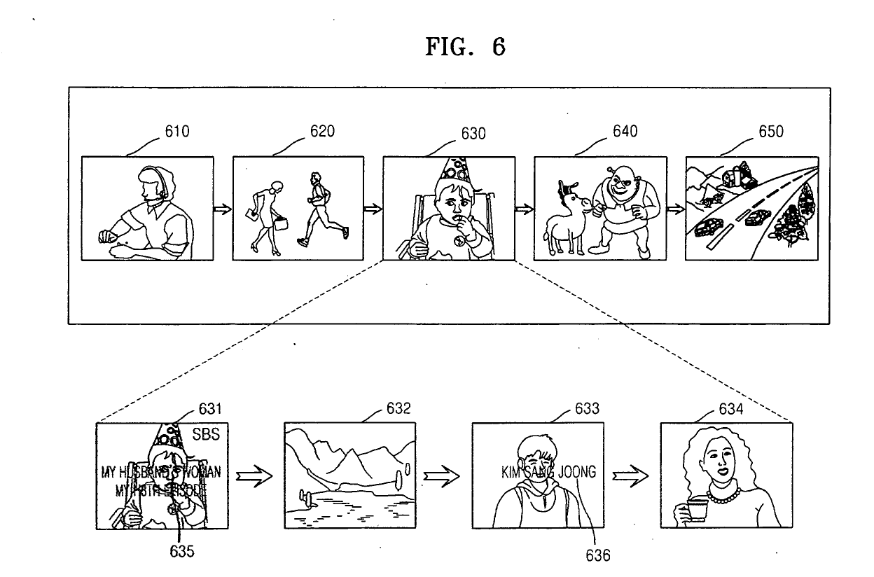

FIG. 6 is a diagram illustrating an example in which a representative video included in program information is temporally illustrated according to an embodiment of the present general inventive concept.

Referring to FIGS. 2 and 6, the program information, which is generated by assembling at least one representative video and at least one piece of additional information which are generated with respect to each item of content, and which is temporally and consecutively displayed. The representative video generation unit 230 extracts a portion from video data of each item of content, and generates the at least one representative video. Also, the additional information extraction unit 240 extracts the at least one piece of additional information from each item of a content. The program information generation unit 250 generates the program information by assembling the generated at least one representative video and the extracted at least one piece of additional information which are related to each item of content, and temporally and consecutively displays the program information about each item of content. That is, a representative video is generated from an item of content, and the generated representative video is assembled with additional information so that program information is generated. Likewise, another piece of program information is generated by performing the aforementioned procedure in regard to another item of content. And then, the program information display apparatus 200 generates a signal representing a plurality of pieces of the program information which are assembled, and temporally and consecutively displayed.

As illustrated in FIG. 6, representative videos 610, 620, 630, 640, and 650 with respect to respective items of the contents are not respectively reproduced in a predetermined area but the representative video 610, that is an initial video, is reproduced and then the representative video 620, that is the next video, is reproduced. In other words, the representative videos 610, 620, 630, 640, and 650, which are generated for each item of a content, are temporally reproduced on a screen. FIG. 6 illustrates various contents as examples of the present embodiment. As a specific item of a content in detail, for example, as a specific item of the content of the representative video 630, an initial image of the representative video 631 displays a content title 635 that is basic information from the additional information, and a next image of the representative video 633 displays a hero name 636 that is another piece of additional information. The representative videos 531 through 634 may be sub-representative videos of the representative video 630 as program information on items (current, previous, next items) of a current channel or may be selected or extracted according to a category of the contents or according to an input of the input unit 204, a user preference input through a menu generated by the UI unit 260, a random selection of the controller 206 or the representative video generation unit 230, or selection data included in the corresponding content.

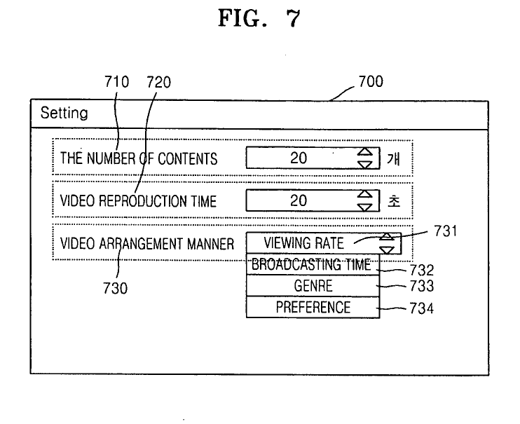

FIG. 7 is a diagram illustrating a user interface 700 to assemble or set up program information according to an embodiment of the present general inventive concept.

Referring to FIGS. 2 and 7, the controller 206 controls the UI unit 270 to generate a signal representing a menu 700 as a user interface to assemble or set up the program information such that a user may decide the number of contents 710 which is to be provided by the program information, a video reproduction time 720, and a video arrangement manner 730 using the input unit 204. The number of contents 710 indicates the number of user desired contents. Also, the user may adjust the video reproduction time 720. The video reproduction time 720 may be a time during which the program information of content is displayed. The user may input a desired time. In this case, the time may be a reproduction time period during which an entire video is temporally and consecutively displayed, or may be a reproduction time for each content. In the case where the time is the reproduction time for the entire video, the reproduction time for each item of content is changed according to the reproduction time for the entire video. In the case of the video arrangement manner 730, an order of contents may be set according to a viewing rate 731, a broadcasting time 732, a genre 733, or a preference 734. Also, the order may be set according to a viewer rating for a specific age group, or according to an Internet retrieval ranking. There may be many examples for a reference used for the video arrangement manner 730. The viewing rate 731, the broadcasting time 732, and the genre 733 may be extracted from additional information, or may be received from another external device. Also, the preference 734 may be extracted by using a specific algorithm.

When the program information is displayed, the UI unit 260 may add more functions. The menu (user interface) generated from the UI unit 260 may further include other options, for example, for a user to determine selection or extraction of the representative video or to select a user preference corresponding to operations of the corresponding units of the program information display apparatus 200.

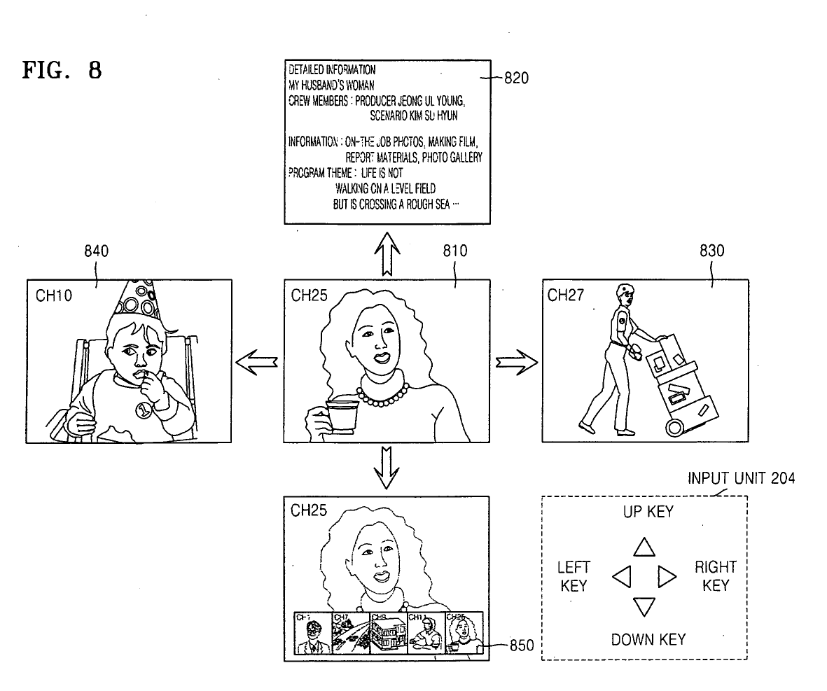

FIG. 8 is a diagram illustrating an example of a user interface UI to provide program information according to another embodiment of the present general inventive concept. Referring to FIGS. 2 and 8, in a case where a representative video 810 of a current content or a current channel is displayed with additional information, when a specific key (for example, a direction key) of the input unit 204 or another input device such as a remote controller is pushed, operations described below are to be performed. For example, when a UP-key of the direction key is pushed, a screen 820 is generated, wherein the screen 820 indicates other additional information which is different from the additional information displayed on the representative video 810 (or channel 25). The other additional information may indicate a detailed description related to the current content. In the case where the program information display apparatus 200 is connected to the Internet, the other additional information may be searched for and downloaded by the additional information search unit 290. Also, the other additional information may be extracted from metadata of the current content. In the case where there are options (not illustrated), when the options are selected, the options may be hyperlinked to a website where the other additional information is listed. When a RIGHT-key is pushed, a representative video 830 (a highlight scene) of a next item of a content (or channel 27) is reproduced, instead of the representative video 810 of the current content. On the other hand, when a LEFT-key is pushed, a representative video 840 of a previous item of a content (or channel 10) is displayed. Also, when a DOWN-key is pushed, the current content is bookmarked. A video list 850 of bookmarked contents is then displayed to include the currently added channel 25. Here, the direction key of the input device is exemplary.

In another embodiment of the present general inventive concept, when a signal indicating a bookmark is received, the program information may be displayed by using only the bookmarked contents. When the representative video 810 of the current content is displayed, if an input signal related to a keyword is received, the program information display apparatus 200 may change the content corresponding to the keyword.

The controller may store one or more contents of the bookmark in the contents storing unit 210 and controls the UI unit 270 to display a list of the contents included in the bookmark on a screen of the display unit 270. It is possible that when the list of the contents of the bookmark is displayed, representative videos and corresponding additional information can be displayed as the respective program information of the contents.

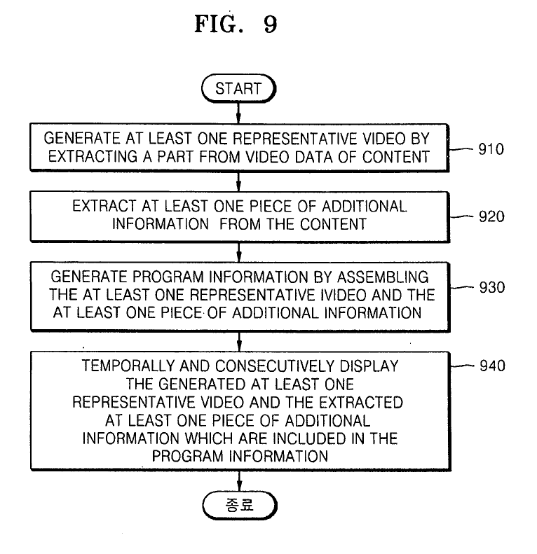

FIG. 9 is a flowchart illustrating a method of displaying program information, according to an embodiment of the present general inventive concept.

Referring to FIG. 9, in operation 910, a portion from video data of a content is extracted so that at least one representative video is generated. That is, a highlight scene is extracted from the content so that the at least one representative video is generated. The extraction of the highlight scene may be performed by using metadata or by using a DCM method. However, the present general inventive concept is not limited thereto. The at least one representative video may be generated by extracting the video data and audio data. In another embodiment of the present general inventive concept, the at least one representative video may be generated by storing one or more contents received via a communication network, and by extracting a portion of video data of the stored contents. The stored contents may be contents which are being received in real-time, contents which have been previously received and stored, or previews of contents which are received but not broadcast yet. Also, in the case where the program information display apparatus 200 is connected to a network such as an Internet network, the stored contents may be VOD contents which exist in a web site. Also, a plurality of representative videos may be generated by extracting a plurality of parts from video data of the received or stored contents. When the at least one representative video is generated, the at least one representative video may be reconstructed by extracting not only the video data but also by further extracting the audio data corresponding to the video data.

In operation 920, at least one piece of additional information, related to the content, is extracted from the content. The at least one piece of additional information includes text data, except for the video and audio data. For example, a title of the content, a broadcasting date, a broadcasting time, channel information, crew members, characters, a background city, and the like. The at least one piece of additional information may also be extracted by using the metadata. When there are a plurality of representative videos, there may be also a plurality of pieces of additional information. The at least one piece of additional information corresponding to the content may be searched for via a communication network, and displayed. For example, the at least one piece of additional information corresponding to the content may be downloaded after connecting to a web site of a contents provider via the Internet, and may be assembled with the generated at least one representative video.

In operation 930, program information is generated by assembling the at least one representative video and the at least one piece of additional information. The program information may be generated by assembling each of representative videos and additional information. An initial image of the representative videos from among the highlight scenes may be assembled with basic additional information including at least one of a content title, a broadcasting date, a broadcasting time, and a channel number. The additional information may be displayed during a predetermined time period.

In operation 940, the generated at least one representative video and the extracted at least one piece of additional information, which are included in the program information, are temporally and consecutively displayed. The extracted at least one piece of additional information may be overlaid on each representative video and displayed, or may be inserted between each of the generated at least one representative video, and displayed, or may be displayed only during the predetermined time.

In another embodiment of the present general inventive concept, program information may be generated by extracting a representative video and additional information from each of a plurality of contents. Then, the representative video and the additional information may be assembled and displayed. That is, a part from video data of each content is extracted so as to generate at least one representative video, at least one piece of additional information related to each content is extracted from each content, the program information is generated by assembling the generated at least one representative video and the extracted at least one piece of additional information which are related to each item of content, and the program information for each item of content is temporally and consecutively displayed. In other words, the representative video is generated from an item of content, and is assembled with the additional information so as to generate the program information. Likewise, another program information related to another item of content is generated by performing the aforementioned procedure. Then, respective program information are temporally and consecutively displayed.

A user may set a first item to determine the number of a plurality of contents, a second item to determine a time period during which the program information of each of the plurality of contents is displayed, and a third item including at least one of a viewing rate, a genre, a preference, and a broadcasting time. In a case where the program information of each of the plurality of contents is displayed, when a first signal from among control signals via an input device, such as the input unit 204 is received, additional information different from the displayed additional information is displayed on a screen, which is different from the displayed program information. When a second signal is received, content corresponding to the displayed program information is bookmarked. When a third signal is received, the program information display apparatus 200 changes to a representative video of content to be displayed next. When a fourth signal is received, the program information display apparatus 200 changes to a representative video of content which was previously displayed. Also, in the case where the program information of each of the plurality of contents is displayed, when an input signal related to a keyword is received, the program information display apparatus 200 extracts the keyword and changes to content corresponding to the extracted keyword.

The present general inventive concept does not reproduce table type program information but reproduces the representative video according to a time flow, and provides the program information, thereby enabling a user to conveniently select content, while enjoying a moving picture, compared to the conventional case in which the user directly selects the content based on the table type program information. Compared to conventional table type program information, the present general inventive concept can efficiently provide more information on contents. The embodiment of the present general inventive concept is an appropriate apparatus to effectively provide a plurality of content to a user.

The method of displaying the program information according to the present general inventive concept can also be embodied as computer readable codes on a computer readable recording medium. The computer readable recording medium is any data storage device that can store data as a program which can be thereafter read by a computer system. Examples of the computer readable recording medium include read-only memory (ROM), random-access memory (RAM), CD-ROMs, magnetic tapes, floppy disks, optical data storage devices. The computer readable recording medium can also be distributed over network coupled computer systems so that the computer readable code is stored and executed in a distributed fashion. Also, functional programs, codes, and code segments for accomplishing the present general inventive concept can be easily construed by programmers of ordinary skill in the art to which the present general inventive concept pertains.

While this present general inventive concept has been particularly shown and described with reference to exemplary embodiments thereof, it will be understood by one of ordinary skill in the art that various changes in form and details may be made therein without departing from the spirit and scope of the general inventive concept as defined by the appended claims. The exemplary embodiments should be considered in a descriptive sense only and not for purposes of limitation. Therefore, the scope of the general inventive concept is defined not by the detailed description of the general inventive concept but by the appended claims, and all differences within the scope will be construed as being included in the present general inventive concept.

What is claimed is:

1. A method of displaying program information, the method comprising:
generating at least one representative video by extracting a portion from video data of a content;
extracting at least one piece of additional information from the content; and
generating the program information by assembling the generated at least one representative video and the extracted at least one piece of additional information.

2. The method of claim 1, further comprising:
temporally and consecutively displaying the generated at least one representative video and the extracted at least one piece of additional information as the program information.

3. The method of claim 1, wherein the generating of the at least one representative video comprises:
storing the content received via a communication network; and
generating the at least one representative video by extracting the part from the video data of the stored content.

4. The method of claim 1, wherein the generating of the at least one representative video comprises generating the at least one representative video by further extracting audio data corresponding to the part extracted from the video data of the content.

5. The method of claim 1, wherein the content comprises VOD (Video on Demand) contents existing in websites via the Internet.

6. The method of claim 1, wherein the extracting of the at least one piece of additional information comprises extracting the at least one piece of additional information from metadata of the content.

7. The method of claim 2, wherein the at least one piece of additional information is displayed during a predetermined time.

8. The method of claim 6, wherein the extracting of the at least one piece of additional information further comprises searching for additional information corresponding to the content via a communication network.

9. The method of claim 6, wherein the displaying comprises first displaying the at least one piece of additional information comprising at least one of a title of the content, a broadcasting date, a broadcasting time, and a channel number.

10. The method of claim 1, further comprising:
generating at least one other representative video by extracting a part from video data of another content different from the content;
extracting at least one other piece of additional information from the other content;
generating another piece of program information by assembling the generated at least one other representative video and the extracted at least one other piece of additional information; and
temporally and consecutively displaying respective program information.

11. The method of claim 10, wherein the displaying comprises temporally and consecutively displaying the respective program information, based on a first item to determine the number of respective contents, a second item to determine a time period during which the respective program information is displayed, and a third item comprising at least one of a viewing rate, a genre, a preference, and a broadcasting time.

12. The method of claim 10, further comprising:
displaying additional information, different from the displayed at least one other additional information, on another screen that is different from a screen on which the program information is displayed when a first signal from among control signals via an input device is received;
bookmarking the content corresponding to the displayed program information when a second signal is received;
changing to a representative video of content to be displayed next when a third signal is received; and
changing to a representative video of content which was previously displayed when a fourth signal is received.

13. The method of claim 10, further comprising:
extracting a keyword when an input signal related to the keyword is received; and
changing to a content corresponding to the extracted keyword.

14. A program information display apparatus comprising:
a representative video generation unit to generate at least one representative video by extracting a part from video data of a content;
an additional information extraction unit to extract at least one piece of additional information from the content; and
a program information generation unit to generate the program information by assembling the generated at least one representative video and the extracted at least one piece of additional information.

15. The program information display apparatus of claim 14, wherein the program information generation unit temporally and consecutively displays the generated at least one representative video and the extracted at least one piece of additional information which are comprised in the program information.

16. The program information display apparatus of claim 14, further comprising:
a contents storage unit to store the content received via a communication network, wherein the representative video generation unit generates the at least one representative video by extracting the part from the video data of the stored content.

17. The program information display apparatus of claim 14, wherein the representative video generation unit generates the at least one representative video by further extracting audio data corresponding to the part extracted from the video data of the content.

18. The program information display apparatus of claim 14, further comprising:
a contents search unit to search for VOD contents existing in one or more websites via the Internet,
wherein the content comprises the VOD contents searched by the contents search unit.

19. The program information display apparatus of claim 14, wherein the at least one piece of additional information is extracted from metadata of the content.

20. The program information display apparatus of claim 19, further comprising:
an additional information search unit to search for additional information corresponding to the content via a communication network.

21. The program information display apparatus of claim 19, wherein the program information generation unit displays the at least one piece of additional information comprising at least one of a title of the content, a broadcasting date, a broadcasting time, and a channel number.

22. The program information display apparatus of claim 20, wherein the at least one piece of additional information is displayed during a predetermined time period.

23. The program information display apparatus of claim 14, wherein:
the representative video generation unit generates at least one other representative video by extracting a part from video data of another content different from the content;
the additional information extraction unit extracts at least one other piece of additional information from the other content; and
the program information generation unit generates another piece of program information by assembling the generated at least one other representative video and the extracted at least one other piece of additional information, and temporally and consecutively displays respective program information.

24. The program information display apparatus of claim 23, further comprising:
a user interface unit to generate a signal to display additional information, different from the displayed at least one other additional information, on another screen that is different from a screen on which the program information is displayed when a first signal from among control signals via an input device is received; to bookmark the content corresponding to the displayed other program information when a second signal is received; to change to a representative video of a content to be displayed next when a third signal is received; and to change to a representative video of content which was previously displayed when a fourth signal is received.

25. The program information display apparatus of claim 24, wherein the UI generates another signal to change to a content corresponding to a keyword when an input signal related to the keyword is received.
